(19) United States
(12) Patent Application Publication
(10) Pub. No.: US 2005/0034531 A1
(43) Pub. Date: Feb. 17, 2005

(54) Process for measuring the tension in a metal strip

(76) Inventor: Thomas William Dashwood Farley, Oxfordshire (GB)

Correspondence Address: Christopher C Dunham;Cooper & Dunham, 1185 Avenue of the Americas, New York, NY, 10036, US

(21) Appl. No.: 10/497,787

(22) PCT Filed: Dec. 10, 2002
(86) PCT No.: PCT/GB02/05600

(30) Foreign Application Priority Data
Dec. 11, 2001 (EP) 01811211.0

(51) Int. Cl. G01N 3/08

(52) U.S. Cl. 73/826

(57) ABSTRACT

In a process for measuring the tension in a metal strip (10) running over two rolls (12, 14; 26, 28) spaced from each other the vibration frequency of the strip between the contact lines (16, 18) at the surface of the rolls is measured and used as a measure of the tension in the strip.

The invention concerns a process for measuring the tension in a metal strip running over two rolls spaced from each other.

For the production of narrow strips of metal it is known to unwind a broad sheet from a coil, divide this in a multiple slitter into the individual strips and subsequently wind these into strip reels. During the process of multislitting, the rewinding tension in the individual cut strips have a range of values above and below the average rewinding tension. This can be due to many factors including the profile on the incoming strip and to a lesser extent the flatness of the incoming strip. Rewinding problems such as weave and dishing can occur if an individual strip is rewound at too low or high a tension, respectively. A measurement of the strip tension would provide the operator with valuable feedback on the current state of the process and the characteristics of the incoming strip.

The objective of the invention is to provide a process for measuring the tension in metal strip running over two rolls spaced from each other. Moreover the process should be applicable to multislitting arrangements.

The objectives are archived according to the invention with the process of the type described initially, wherein the vibration frequency of the strip between the contact lines at the surface of the rolls is measured and used as a measure of the tension in the strip.

The vibration frequencies include fundamental and harmonics of fundamental transitional modes and modes of vibration involving twisting and/or flexing of the strip.

Preferably, the tension in the strip is calculated according to the equation

$${f}_{0} = \frac{1}{2 L} √ \frac{T}{Wtp}$$

where f₀ is the frequency of the fundamental transitional mode of vibration, L is the length of the strip between the rolls, W is the width of the strip, t is the thickness of the strip, p is the density of the strip and T is the tension in the strip.

The frequency may be measured with any kind of vibration sensor. Preferably, a non-contact sensor such as a laser vibrometer, an inductive proximity sensor, a capacity sensor, an optical displacement sensor using reflection angle changes or an ultrasonic or sonic sensor using air pressure pulses is used to measure the vibration frequency of the strip.

The process according to the invention is suitable in particular to control the tension in a running strip, in particular to measure and/or control the tension of strips in a slitter arrangement.

The strip vibrations occurring simply due to the slitter process may be used to measure the vibration frequencies, or the strip vibrations occurring due to the slitter process may be additionally excited.

Further advantages, features and details of the invention arise from the description below of preferred embodiments and the drawings which show schematically:

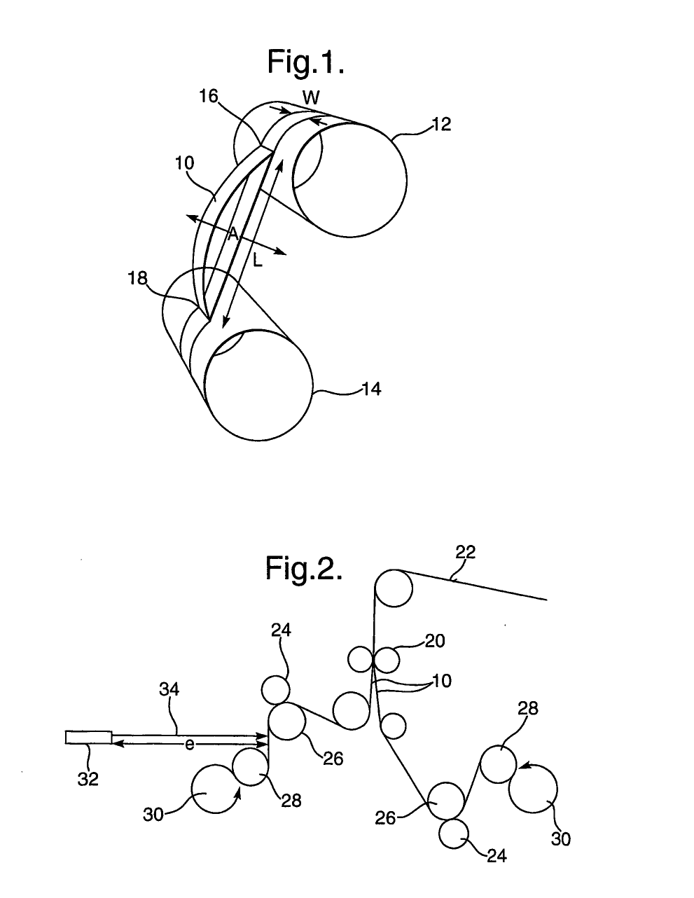

FIG. 1 the fundamental translational mode of vibration of a strip between two rolls;

FIG. 2 a slitter arrangement using the process according to the invention.

As shown in FIG. 1, a strip 10 of metal, e.g. an aluminium strip, is guided over two rolls 12, 14 spaced from each other. The contact lines 16, 18 of the metal strip 10 at the surface of the first roll 12 and the second roll 14, respectively, define constraining end conditions where no vibrational motion is permitted. The contact lines 16, 18 define vibration nodes. The section of the strip 10 between the rolls 12, 14 is free to vibrate in the direction indicated by the arrow A.

The fundamental transitional mode of vibration involves a strip 10 moving out of plane, without twisting, with a single antinode at the midpoint of the strip between the two rolls 12, 14. This mode is displayed in FIG. 1. The frequency f₀ [Hz] of this fundamental natural mode is given by the equation

$${f}_{0} = \frac{1}{2 L} √ \frac{T}{Wtp}$$

where L [m] is the length of the strip between the rolls, W [m] is the width of the strip, t [m] is the thickness of the strip, p is the density [kg/m³] of the strip and T [N] is the tension of the strip. Harmonics of this fundamental frequency f₀ with 2, 3, 4, etc antinodes will have mode frequencies equal to 2 f₀, 3 f₀, 4 f₀, etc.

On the basis of the theoretical model shown in FIG. 1, the tension in the strip can be calculated by measuring the frequency of vibration of the strip at a location in a process where the strip is effectively in between two constraining points, e.g. two rolls. Any strip of metal that is held under tension between two points that act as vibration nodes will have predictable natural resonant frequencies of vibration. The frequencies will be related to the strip tension like the strings in a musical instrument. Knowing the dimensions of the strip and measuring the resonant frequencies, the tension in the strip can be easily calculated.

The multislitter arrangement shown in FIG. 2 comprises a multislitter 20 where a sheet 22 unwound from a coil (not shown) is cut into a series of strips 10. The strips 10 are further guided through pinch rolls 24, 26 over an ironing roll 28 and finally wound into a coil 30.

The laser beam 34 of a laser vibrometer 32 is directed to the strip 10 between pinch roll 26 and ironing roll 28. Pinch roll 26 and ironing roll 28 correspond to first and second rolls 12, 14 shown in FIG. 1.

The laser vibrometer 32 used in the arrangement of FIG. 2 was a Polytec laser doppler vibrometer using a laser to measure the velocity and displacement of points on a vibrating structure without contacting the structure. The vibrometer operates according to principles of laser interferometry except that the laser beam frequency is also modulated using a Bragg Cell to distinguish between structural motion towards and away from the laser head. Displacement as small as about 1 nm can be detected over a frequency range of approximately DC to 20 MHz. The standard laser vibrometer measures vibration at a single point on the structure. The laser beam must be roughly perpendicular to the motion of the surface being measured, depending on the surface roughness. Measurements from rougher surfaces can be made for a wider range of angles. Aluminium sheet provides a strong reflected signal for the vibrometer but the alignment of the laser beam is more critical that for a matt surface.

The distance between the laser vibrometer 32 and the strips 10 running between pinch roll 26 and ironing roll 28 was 3 m. Measurements were made during slitting of an aluminium sheet having a width W of 1500 mm and a thickness t of 0.36 mm into strips 10 having a width of 41.6 mm. The vibrometer was relocated to measure vibrations of central and edge strips at most times during the build up. The average strip tension was maintained at 27 N/mm².

It was found that the process itself provided sufficient energy to excite the strips 10 into vibration and a significant displacement of the strips 10 was measured, typically several hundred microns. By performing an FFT (fast fourier transform) of the vibrometer output, the vibration frequency can be determined.

In combination with signal analysis techniques (e.g. FFT) the laser vibrometer 32 is capable of accurately measuring fundamental vibration frequencies f₀ in different strips 10, providing measurement of differences in strip tensions.

Further experimental work has been done using an inductive proximity sensor. The average tension of the strips 10 calculated from measured frequencies f₀ is consistent with the average tension calculated from rewind motor torque. The sensor used for the measurements was a Pepperl+Fuchs IA5-18GM-I3, which gives a 0 to 20 mA current output that is linear with distance from a metal target over a range of 2 to 5 mm. The vibrometer “sees” a target area of 20×20 mm. Placed near a strip 10, the vibration frequency f₀ of the strip is determined by doing a FFT (fast fourier transform) of the sensor output. The tension of the strip can be calculated using the aforementioned equation.

1. Process for measuring the tension in a metal strip (10) running over two rolls (12,14; 26,28) spaced from each other, wherein a natural resonant frequency of vibration of the strip resulting from the motion of the metal strip (10) over the two rolls (12, 14; 26,28), between the contact lines (16,18) at the surface of the rolls, is measured and used as a measure of the tension in the strip.

2. Process according to claim 1, characterised in that the vibration frequencies include fundamental and harmonics of fundamental transitional modes and modes of vibration involving twisting and/or flexing of the strip.

3. Process according to claim 1, characterised in that the tension in the strip (10) is calculated according to the equation
$${f}_{0} = \frac{1}{2 L} √ \frac{T}{Wtp}$$
where f₀ is a frequency of the fundamental transitional mode of vibration, L is the length of the strip between the rolls, W is the width of the strip, t is the thickness of the strip, p is the density of the strip and T is the tension in the strip.

4. Process according to claim 1, characterised in that the frequency is measured with a vibration sensor (32).

5. Process according to claim 4, characterised in that the vibration sensor (32) is a non-contact sensor such as a laser vibrometer, an inductive proximity sensor, a capacitive sensor, an optical displacement sensor or an ultrasonic or sonic sensor.

6. Process according to claim 1, characterised in that the measured vibration frequency is used to control the tension in a running strip (10).

7. Process according to claim 1, characterised in that the measured vibration frequency is used to measure and/or control the tension of strips (10) in a slitter arrangement (20).

8. Process according to claim 1, characterised in that the vibration frequencies occurring due to the slitter process are measured.

9. Process according to claim 8, characterised in that the vibration frequencies occurring due to the slitter process are additionally excited.
